(19) United States
(12) Patent Application Publication
(10) Pub. No.: US 2016/0212749 A1
(43) Pub. Date: Jul. 21, 2016

(54) SYSTEMS AND METHODS FOR USE OF MULTIPLE MODULATION AND CODING SCHEMES IN A PHYSICAL PROTOCOL DATA UNIT

(71) Applicant: QUALCOMM Incorporated, San Diego, CA (US)

(72) Inventors: Santosh Paul Abraham, San Diego, CA (US); Alireza Raissinia, Monte Sereno, CA (US); Sameer Vermani, San Diego, CA (US)

(21) Appl. No.: 14/957,171

(22) Filed: Dec. 2, 2015

Related U.S. Application Data
(60) Provisional application No. 62/105,131, filed on Jan. 19, 2015.

(51) Int. Cl. H04W 72/04; H04W 52/60

(52) U.S. Cl. CPC H04W 72/0473; H04W 52/60

(57) ABSTRACT

Systems, methods, and apparatuses for communicating multi-destination traffic are provided. One aspect of this disclosure provides a method of communicating including generating a wireless frame including first and second data portions, and a transmission schedule indicating the first data portion is transmitted using a first modulation and coding scheme (MCS) and the second data portion is transmitted using a second modulation and coding (MCS) scheme. The method may also include transmitting the frame, wherein the first portion is transmitted using the first modulation and coding scheme to a first device and the second portion is transmitted using the second modulation and coding scheme to a second device.

### CROSS REFERENCE TO RELATED APPLICATIONS

This application claims priority to U.S. Provisional Application No. 62/105,131, filed Jan. 19, 2015, and entitled “SYSTEMS AND METHODS FOR USE OF MULTIPLE MODULATION AND CODING SCHEMES IN A PHYSICAL PROTOCOL DATA UNIT.” The disclosure of this prior application is considered part of this application, and is hereby incorporated by reference in its entirety.

### FIELD

The present application relates generally to wireless communications, and more specifically to systems, methods, and devices for transmission of a physical protocol data unit using multiple modulation and coding schemes.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

The transmission capacity of wireless networks is finite. As the deployment of wireless solutions expands, consumption of the available finite capacity increases. In some deployment scenarios, available wireless capacity can be a limiting factor in whether a wireless solution is available. Thus, a need exists to increase the efficiency of wireless transmissions to reduce overall consumption of wireless network capacity, thus increasing available capacity to further the growth of wireless based solutions.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of this disclosure provides a method of communicating on a wireless network. The method includes generating a frame, the frame comprising a first data portion and a second data portion, and a transmission schedule indicating the first data portion is transmitted using a first modulation and coding scheme (MCS) and the second data portion is transmitted using a second modulation and coding (MCS) scheme; and transmitting the frame, wherein the first portion is transmitted using the first modulation and coding scheme to a first device and the second portion is transmitted using the second modulation and coding scheme to a second device.

In some aspects of the method, the first portion of the frame is also transmitted to a third device. In some of these aspects, the second portion of the frame is also transmitted to a fourth device. Some aspects of the method further include generating the transmission schedule to further indicate a starting symbol of the second portion. Some aspects of the method also include generating the transmission schedule to further indicate a first power level used for transmission of the first portion and a second power level used for transmission of the second portion. Some aspects of the method include transmitting a guard interval between transmission of the first data portion and the second data portion, wherein transmission of the guard interval comprises transitioning from transmitting at the first modulation and coding scheme to the second modulation and coding scheme. Some aspects of the method also include generating the frame to further comprise one or more training fields between the first data portion and the second data portion. Some aspects of the method also include generating the frame to further comprise a delimiter between the first data portion and the second data portion, wherein the delimiter is a series of predetermined bit values indicating an end of transmission of the first data portion. Some aspects of the method include generating the transmission schedule to indicate a first number of spatial streams used to transmit the first data portion and a second number of spatial streams used to transmit the second data portion. Some aspects of the method include generating the transmission schedule to include a bitmap indicating modulation and coding schemes used during transmission of the frame, first determining the first device may receive data using the first modulation and coding scheme, setting a first bit in the bitmap corresponding to the first modulation and coding scheme based on the first determining, second determining the second device may receive data using the second modulation and coding scheme; and setting a second bit in the bitmap corresponding to the second modulation and coding scheme based on the second determining. Some aspects of the method include ordering the first data portion and second data portion in the frame based on the modulation and coding scheme used for transmission of the first data portion and the modulation and coding scheme used for transmission of the second data portion.

Another aspect disclosed is an apparatus for communicating on a wireless network. The apparatus includes a processor configured to generate a frame, the frame comprising a first data portion and a second data portion, and a transmission schedule indicating the first data portion is transmitted using a first modulation and coding scheme (MCS) and the second data portion is transmitted using a second modulation and coding (MCS) scheme; and a transmitter configured to transmit the frame, wherein the transmitter is configured to transmit the first portion using the first modulation and coding scheme to a first device and the transmitter is configured to transmit the second portion using the second modulation and coding scheme to a second device. In some aspects, the transmitter is further configured to transmit the first portion of the frame to a third device. In some of these aspects, the transmitter is further configured to transmit the second portion of the frame to a fourth device.

In some aspects of the apparatus, the processor is further configured to generate the transmission schedule to further indicate a starting symbol of the second portion. In some aspects of the apparatus, the processor is further configured to generate the transmission schedule to further indicate a first power level used for transmission of the first portion and a second power level used for transmission of the second portion. In some aspects of the apparatus, the processor is further configured to transmit a guard interval between transmission of the first data portion and the second data portion, wherein transmission of the guard interval comprises transitioning from transmitting at the first modulation and coding scheme to the second modulation and coding scheme.

In some aspects of the apparatus, the processor is further configured to generate the frame to further comprise one or more training fields between the first data portion and the second data portion. In some aspects of the apparatus, the processor is further configured to generate the frame to further comprise a delimiter between the first data portion and the second data portion, wherein the delimiter is a series of predetermined bit values indicating an end of transmission of the first data portion.

In some aspects of the apparatus, the processor is further configured to generate the transmission schedule to indicate a first number of spatial streams used to transmit the first data portion and a second number of spatial streams used to transmit the second data portion.

In some aspects of the apparatus, the processor is further configured to generate the transmission schedule to include a bitmap indicating modulation and coding schemes used during transmission of the frame, first determine the first device may receive data using the first modulation and coding scheme, set a first bit in the bitmap corresponding to the first modulation and coding scheme based on the first determining, second determine the second device may receive data using the second modulation and coding scheme, and set a second bit in the bitmap corresponding to the second modulation and coding scheme based on the second determining.

In some aspects of the apparatus, the processor is further configured to order the first data portion and second data portion in the frame based on the modulation and coding scheme used for transmission of the first data portion and the modulation and coding scheme used for transmission of the second data portion.

Another aspect disclosed is an apparatus for communicating on a wireless network. The apparatus includes means for generating a frame, the frame comprising: a first data portion and a second data portion, and a transmission schedule indicating the first data portion is transmitted using a first modulation and coding scheme (MCS) and the second data portion is transmitted using a second modulation and coding (MCS) scheme; and means for transmitting the frame, wherein the means for transmitting is configured to transmit the first portion of the frame using the first modulation and coding scheme to a first device and the second portion of the frame using the second modulation and coding scheme to a second device. In some aspects of the apparatus, the means for transmitting is further configured to transmit the first portion of the frame to a third device. In some of these aspects of the apparatus, the means for transmitting is further configured to transmit the second portion of the frame to a fourth device.

Some aspects of the apparatus include means for generating the transmission schedule to further indicate a starting symbol of the second portion. Some aspects of the apparatus include means for generating the transmission schedule to further indicate a first power level used for transmission of the first portion and a second power level used for transmission of the second portion. Some aspects of the apparatus include means for transmitting a guard interval between transmission of the first data portion and the second data portion, wherein transmission of the guard interval comprises transitioning from transmitting at the first modulation and coding scheme to the second modulation and coding scheme. Some aspects of the apparatus include means for generating the frame to further comprise one or more training fields between the first data portion and the second data portion. Some aspects of the apparatus include means for generating the frame to further comprise a delimiter between the first data portion and the second data portion, wherein the delimiter is a series of predetermined bit values indicating an end of transmission of the first data portion.

Some aspects of the apparatus include means for generating the transmission schedule to indicate a first number of spatial streams used to transmit the first data portion and a second number of spatial streams used to transmit the second data portion. Some aspects of the apparatus include means for generating the transmission schedule to include a bitmap indicating modulation and coding schemes used during transmission of the frame, means for first determining the first device may receive data using the first modulation and coding scheme, means for setting a first bit in the bitmap corresponding to the first modulation and coding scheme based on the first determining, means for second determining the second device may receive data using the second modulation and coding scheme; and means for setting a second bit in the bitmap corresponding to the second modulation and coding scheme based on the second determining.

Some aspects of the apparatus include means for ordering the first data portion and second data portion in the frame based on the modulation and coding scheme used for transmission of the first data portion and the modulation and coding scheme used for transmission of the second data portion.

Another aspect disclosed is a computer readable storage medium comprising instructions that when executed cause a processor to perform a method of communicating on a wireless network. The method includes generating a frame, the frame including a first data portion and a second data portion, and a transmission schedule indicating the first data portion is transmitted using a first modulation and coding scheme (MCS) and the second data portion is transmitted using a second modulation and coding (MCS) scheme; and transmitting the frame, wherein the first portion is transmitted using the first modulation and coding scheme to a first device and the second portion is transmitted using the second modulation and coding scheme to a second device.

In some aspects of the method, the first portion of the frame is also transmitted to a third device. In some of these aspects, the second portion of the frame is also transmitted to a fourth device. Some aspects of the method further include generating the transmission schedule to further indicate a starting symbol of the second portion. Some aspects of the method also include generating the transmission schedule to further indicate a first power level used for transmission of the first portion and a second power level used for transmission of the second portion. Some aspects of the method include transmitting a guard interval between transmission of the first data portion and the second data portion, wherein transmission of the guard interval comprises transitioning from transmitting at the first modulation and coding scheme to the second modulation and coding scheme. Some aspects of the method also include generating the frame to further comprise one or more training fields between the first data portion and the second data portion. Some aspects of the method also include generating the frame to further comprise a delimiter between the first data portion and the second data portion, wherein the delimiter is a series of predetermined bit values indicating an end of transmission of the first data portion. Some aspects of the method include generating the transmission schedule to indicate a first number of spatial streams used to transmit the first data portion and a second number of spatial streams used to transmit the second data portion. Some aspects of the method include generating the transmission schedule to include a bitmap indicating modulation and coding schemes used during transmission of the frame, first determining the first device may receive data using the first modulation and coding scheme, setting a first bit in the bitmap corresponding to the first modulation and coding scheme based on the first determining, second determining the second device may receive data using the second modulation and coding scheme; and setting a second bit in the bitmap corresponding to the second modulation and coding scheme based on the second determining. Some aspects of the method include ordering the first data portion and second data portion in the frame based on the modulation and coding scheme used for transmission of the first data portion and the modulation and coding scheme used for transmission of the second data portion.

Another aspect disclosed is a method of communicating on a wireless network, including receiving, by a first device, a wireless frame from a wireless network, the wireless frame comprising a first data portion and a second data portion, decoding the wireless frame to determine a first modulation and coding scheme (MCS) of the first data portion and a second different modulation and coding scheme (MCS) of the second data portion; and decoding the first data portion based on the first MCS.

Another aspect disclosed is an apparatus for communicating on a wireless network. The apparatus includes a receiver configured to receive a wireless frame from a wireless network, the wireless frame comprising a first data portion and a second data portion, a processor configured to: decode the wireless frame to determine a first modulation and coding scheme (MCS) of the first data portion and a second different modulation and coding scheme (MCS) of the second data portion; and decode the first data portion based on the first MCS.

Another aspect disclosed is an apparatus for communicating on a wireless network. The apparatus includes means for receiving a wireless frame from a wireless network, the wireless frame comprising a first data portion and a second data portion, means for decoding the wireless frame to determine a first modulation and coding scheme (MCS) of the first data portion and a second different modulation and coding scheme (MCS) of the second data portion; and means for decoding the first data portion based on the first MCS.

Another aspect disclosed is a computer readable storage medium comprising instructions that when executed cause a processor to perform a method of communicating on a wireless network, the method comprising receiving, by a first device, a wireless frame from a wireless network, the wireless frame comprising a first data portion and a second data portion, decoding the wireless frame to determine a first modulation and coding scheme (MCS) of the first data portion and a second different modulation and coding scheme (MCS) of the second data portion; and decoding the first data portion based on the first MCS.

### BRIEF DESCRIPTION OF THE DRAWINGS

FIG. 1 shows an exemplary wireless communication system in which aspects of the present disclosure may be employed.

FIG. 2 is a message flow diagram of communication between an access point and three stations.

FIG. 3 is a message flow diagram of communication between an access point and three stations.

FIG. 4 shows a functional block diagram of an exemplary wireless device that may be employed within the wireless communication systems of FIGS. 1, 2, and 3.

FIG. 5 illustrates an aggregated media access control protocol data unit.

FIG. 6A illustrates one implementation of the SMSF field 508 of FIG. 5.

FIG. 6B illustrates another implementation of the SMSF field 508 of FIG. 5.

FIG. 7 illustrates a method of transmitting a wireless frame on a wireless network.

FIG. 8 illustrates a method of receiving a wireless frame from a wireless network.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing the high-efficiency 802.11 protocol using the techniques disclosed herein may include allowing for increased peer-to-peer services (e.g., Miracast, WiFi Direct Services, Social WiFi, etc.) in the same area, supporting increased per-user minimum throughput requirements, supporting more users, providing improved outdoor coverage and robustness, and/or consuming less power than devices implementing other wireless protocols.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement a high-efficiency 802.11 standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications. Although various systems, methods, and apparatuses are described herein with respect to a high-efficiency 802.11 standard, for example, a person having ordinary skill in the art will appreciate that the present disclosure is applicable to other wireless communication standards such as, for example, 802.11ah.

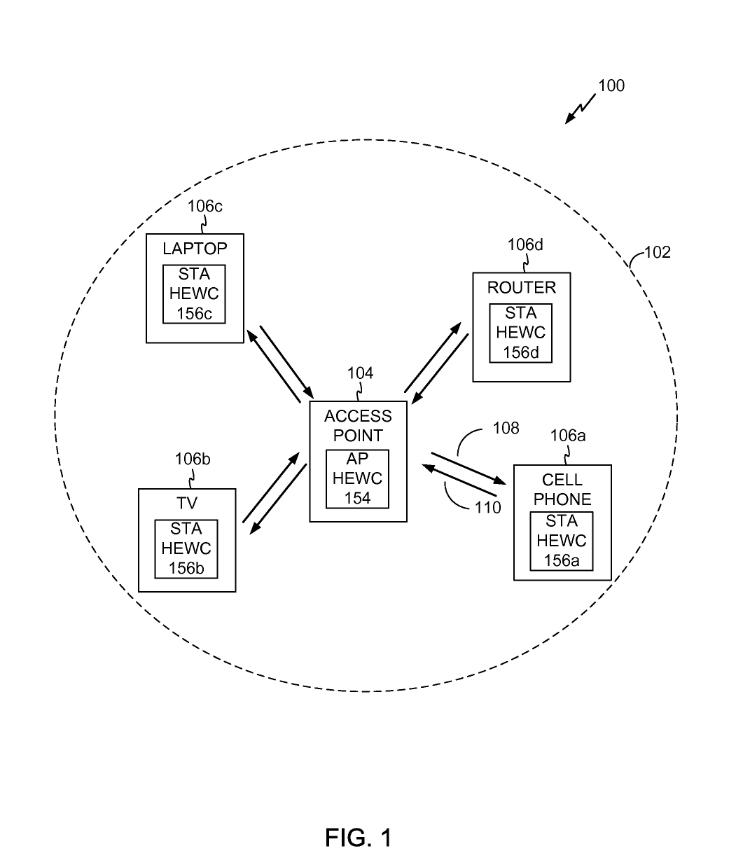

FIG. 1 shows an exemplary wireless communication system 100 in which aspects of the present disclosure may be employed. The wireless communication system 100 may operate pursuant to a wireless standard, for example a high-efficiency 802.11 standard. The wireless communication system 100 may include an AP 104, which communicates with STAs 106 (referring generally to the STAs 106A-106D).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

In some aspects, a STA 106 may be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

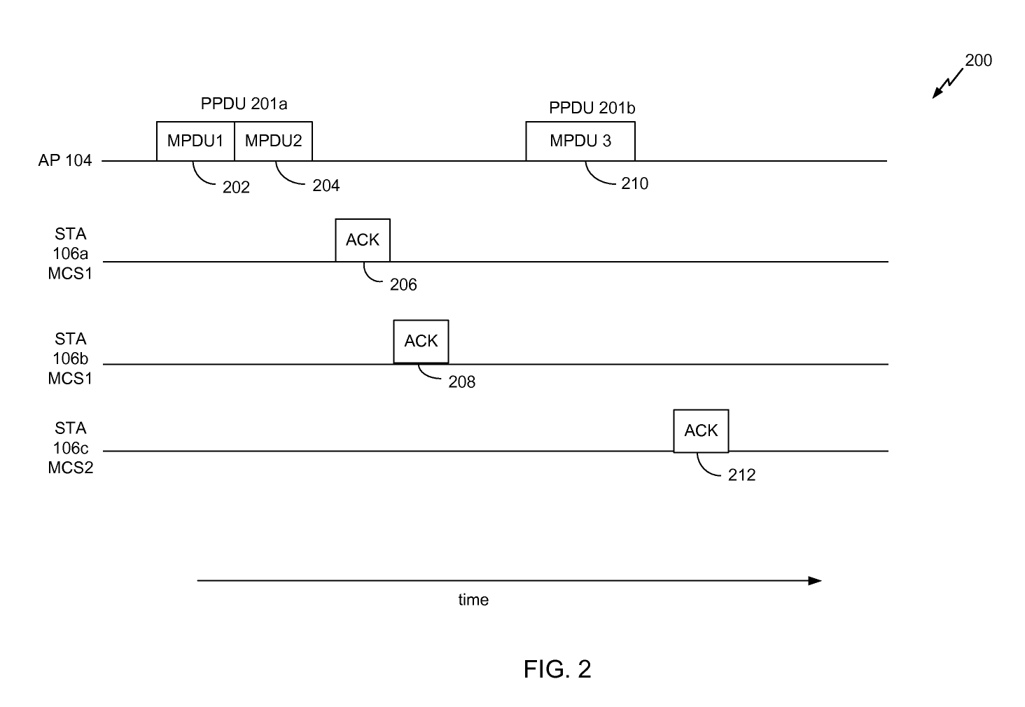

In an embodiment, the AP 104 includes an AP high-efficiency wireless component (HEWC) 154. The AP HEWC 154 may perform some or all of the operations described herein to enable communications between the AP 104 and the STAs 106 using the high-efficiency 802.11 protocol. The functionality of the AP HEWC 154 is described in greater detail below with respect to FIGS. 2, 3, 4, and 5-8.

Alternatively or in addition, the STAs 106 may include a STA HEWC 156. The STA HEWC 156 may perform some or all of the operations described herein to enable communications between the STAs 106 and the AP 104 using the high-frequency 802.11 protocol. The functionality of the STA HEWC 156 is described in greater detail below with respect to FIGS. 2, 3, 4, and 5-8.

FIG. 2 is a message flow diagram of communication between an access point and three stations. Message flow 200 illustrates an access point 104, and three stations 106a-c. Stations 106a-b support the same modulation and coding scheme, i.e., MCS 1. Station 106c supports a different modulation and coding scheme, i.e., MCS 2. In message flow 200, the access point 104 is transmitting an aggregated media access control protocol data unit (A-MPDU) PPDU 201a to the first and second station 106a and 106b. Because station 106c supports a different modulation and coding scheme than stations 106a-b, a separate A-MPDU (PPDU 201b) is transmitted to the station 106c.

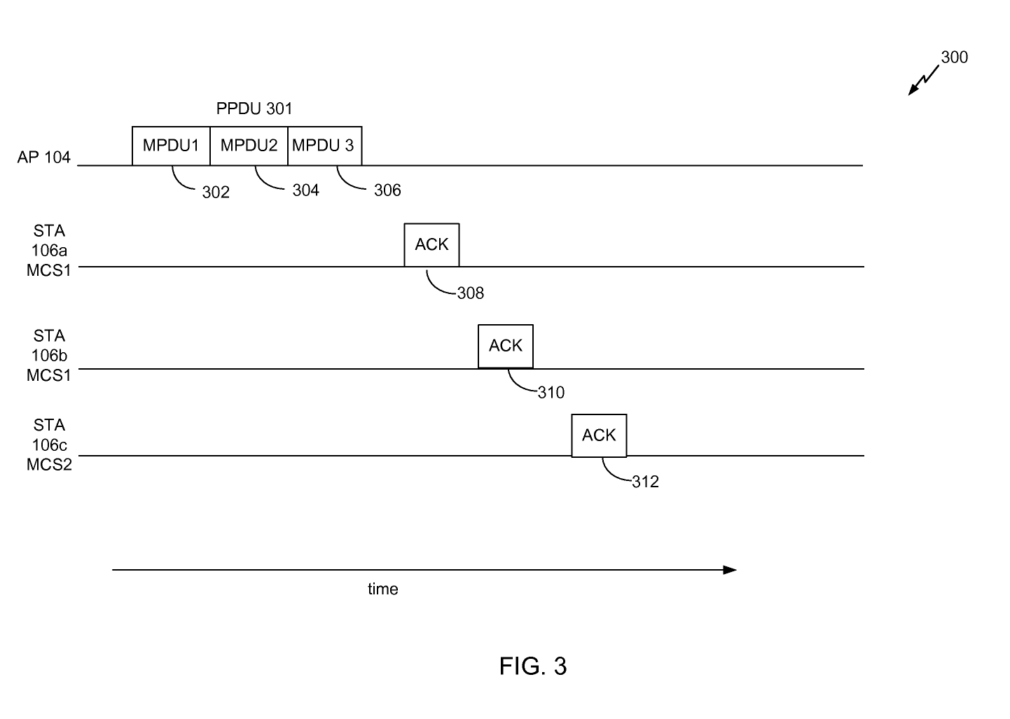

FIG. 3 is a message flow diagram of communication between an access point and three stations. Similar to FIG. 2, message flow 300 illustrates an access point 104, and the three stations 106a-c. Stations 106a-b support the same modulation and coding scheme, i.e. MCS 1. As in FIG. 2, station 106c supports a different modulation and coding scheme i.e. MCS 2. In message flow 300 however, in contrast with FIG. 2, the access point 104 is transmitting an aggregated media access control protocol data unit (A-MPDU) PPDU 301 to all of the stations 106a-c. The PPDU 301 is transmitted to all three stations despite the station 106c supporting a different modulation and coding scheme than the stations 106a-b. The capability to transmit a single PPDU 301 to a plurality of stations, using at least two different modulation and coding schemes to encode the PPDU 301 is enabled by the methods and systems disclosed herein. Note that while FIG. 3 illustrates each of the MPDUs 302, 304, and 306 being transmitted to a single station, in some aspects, one or more of the MPDUs 302, 304, and 306 may be transmitted to multiple stations by the PPDU 301.

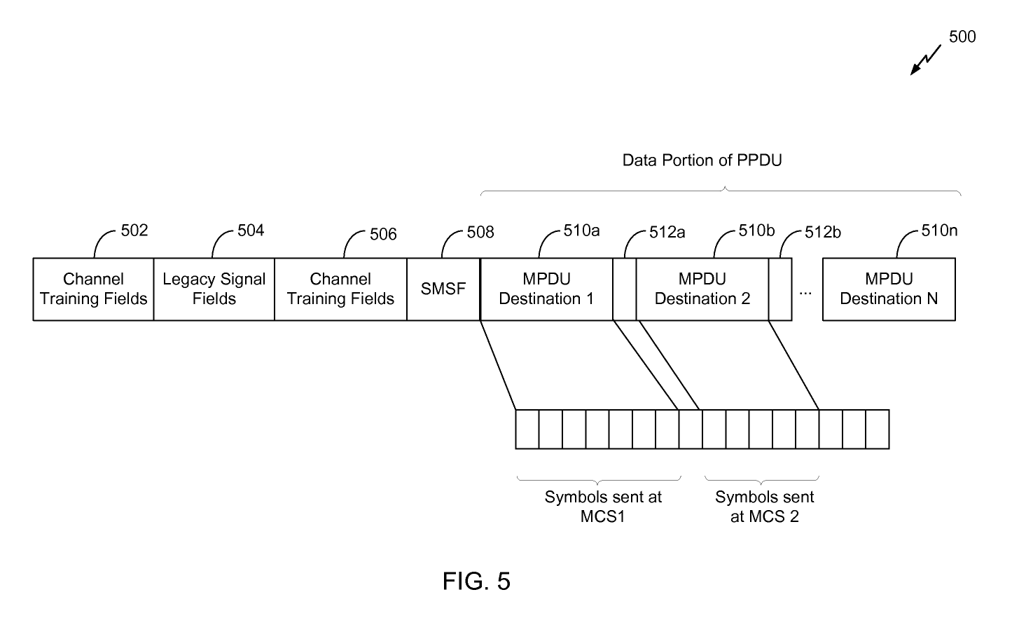

Upon reception of the PPDU 301, each of STAs 106a-c transmits an acknowledgment message 308, 310, and 312 respectively. In some aspects, the PPDU 301 may substantially conform with the frame 500, discussed below with respect to FIG. 5.

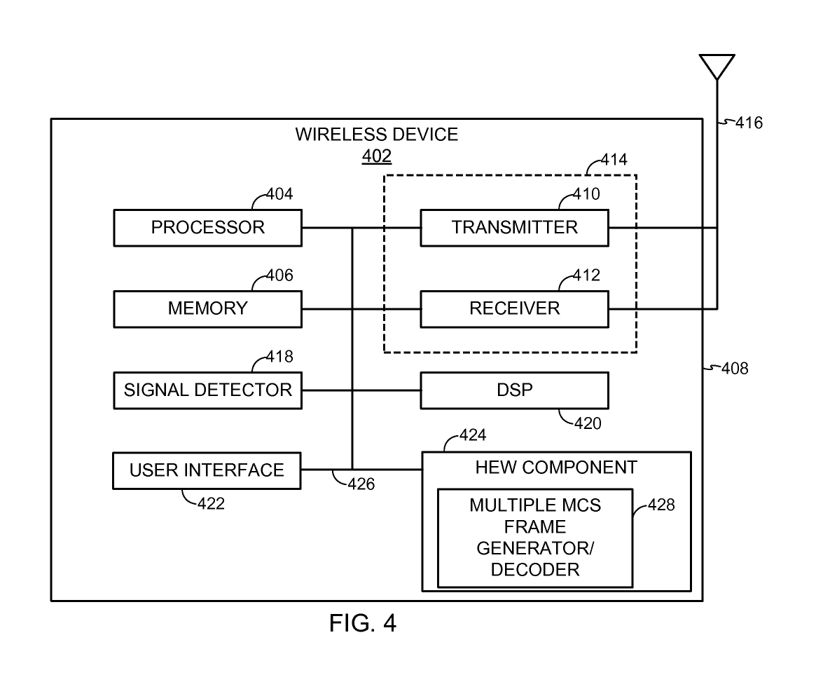

FIG. 4 shows an exemplary functional block diagram of a wireless device 402 that may be employed within the wireless communication system 100 of FIG. 1, or the message flows 200, and/or 300 of FIGS. 2, and 3. The wireless device 402 is an example of a device that may be configured to implement the various methods described herein. For example, the wireless device 402 may comprise the AP 104, and/or one of the STAs 106.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408 that may include a transmitter 410 and/or a receiver 412 to allow transmission and reception of data between the wireless device 402 and a remote location. The transmitter 410 and receiver 412 may be combined into a transceiver 414. An antenna 416 may be attached to the housing 408 and electrically coupled to the transceiver 414. The wireless device 402 may also include (not shown) multiple transmitters, multiple receivers, multiple transceivers, and/or multiple antennas.

The transmitter 410 can be configured to wirelessly transmit messages, which can be referred to as “paging messages” that are configured to indicate to wireless devices whether or not the wireless devices need to wake up from a doze state and enter an awake state as discussed below. For example, the transmitter 410 can be configured to transmit paging messages generated by the processor 404, discussed above. When the wireless device 402 is implemented or used as a STA 106, the processor 404 can be configured to process paging messages. When the wireless device 402 is implemented or used as an AP 104, the processor 404 can also be configured to generate paging messages.

The receiver 412 can be configured to wirelessly receive paging messages. When the wireless device 402 is implemented or used as a STA 106, the transmitter 410 can be configured to transmit requests for data in response to the paging messages. For example, the wireless device 402 can be configured to transmit a Power-Saving Poll (PS-Poll) as will be described herein with respect to FIG. 4. When the wireless device 402 is implemented or used as an AP 104, the transmitter 410 can be further configured to transmit data to the one or more STAs 106. When the wireless device 402 is implemented or used as a STA 106, the transmitter 410 can be configured to transmit an acknowledgment to the data received from the AP 104.

The wireless device 402 may also include a signal detector 418 that may be used in an effort to detect and quantify the level of signals received by the transceiver 414. The signal detector 418 may detect such signals as total energy, energy per subcarrier per symbol, power spectral density and other signals. The wireless device 402 may also include a digital signal processor (DSP) 420 for use in processing signals. The DSP 420 may be configured to generate a packet for transmission. In some aspects, the packet may comprise a physical layer data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

The wireless devices 402 may further comprise a high-efficiency wireless component 424 in some aspects. The high-efficiency wireless component 424 may include a multiple MCS frame encoder/decoder 428. In some aspects of wireless device 402, the high-efficiency wireless component 424 may be configured to perform either an encoding or a decoding function. For example, in some aspects, when the wireless device 402 is implementing an access point, the high-efficiency wireless component 424 may encode a frame utilizing multiple modulation and coding schemes (MCS). When the wireless device 402 is implementing a wireless device such as a station, the high-efficiency wireless component 424 may decode a received frame utilizing multiple modulation and coding schemes (MCS). As described herein, the high-efficiency wireless component 424 may enable APs and/or STAs to use a modified mechanism that reduces overhead associated with transmitting multiple MPDUs to devices supporting multiple modulation and coding schemes by allowing those MPDUs to be aggregated into a single aggregated media access control protocol data unit (A-MPDU).

The various components of the wireless device 402 may be coupled together by a bus system 426. The bus system 426 may include a data bus, for example, as well as a power bus, a control signal bus, and a status signal bus in addition to the data bus. Those of skill in the art will appreciate the components of the wireless device 402 may be coupled together or accept or provide inputs to each other using some other mechanism.

Although a number of separate components are illustrated in FIG. 4, those of skill in the art will recognize that one or more of the components may be combined or commonly implemented. For example, the processor 404 may be used to implement not only the functionality described above with respect to the processor 404, but also to implement the functionality described above with respect to the signal detector 418 and/or the DSP 420. Further, each of the components illustrated in FIG. 4 may be implemented using a plurality of separate elements.

The wireless device 402 may comprise an AP 104, and/or a STA 106, and may be used to transmit and/or receive communications. Certain aspects contemplate signal detector 418 being used by software running on memory 406 and processor 404 to detect the presence of a transmitter or receiver.

FIG. 5 illustrates an aggregated media access control protocol data unit frame 500. The A-MPDU frame 500 includes channel training fields 502, legacy signal fields 504, channel training fields 506, and a symbol modulation and coding scheme (MCS) signal field (SMSF) 508. The channel training fields may include a sequence of symbols, such as 1, 2, 4, 6, 8 or 12 symbols. The symbols may be transmitted in some aspects, using OFDM PHY modulation. The symbols may represent a sequence that is known to both a transmitter and a receiver. The symbols may be used by a receiver to perform channel estimation, such as determination of a channel matrix. For example, a receiver may use the training fields to identify a start of an 802.11 frame. The sequence of symbols may assist a receiver with synchronization of timing, and/or selecting an antenna. In some aspects, the sequence of symbols assist a receiver in detecting a repeating pattern and setting receiver gain.

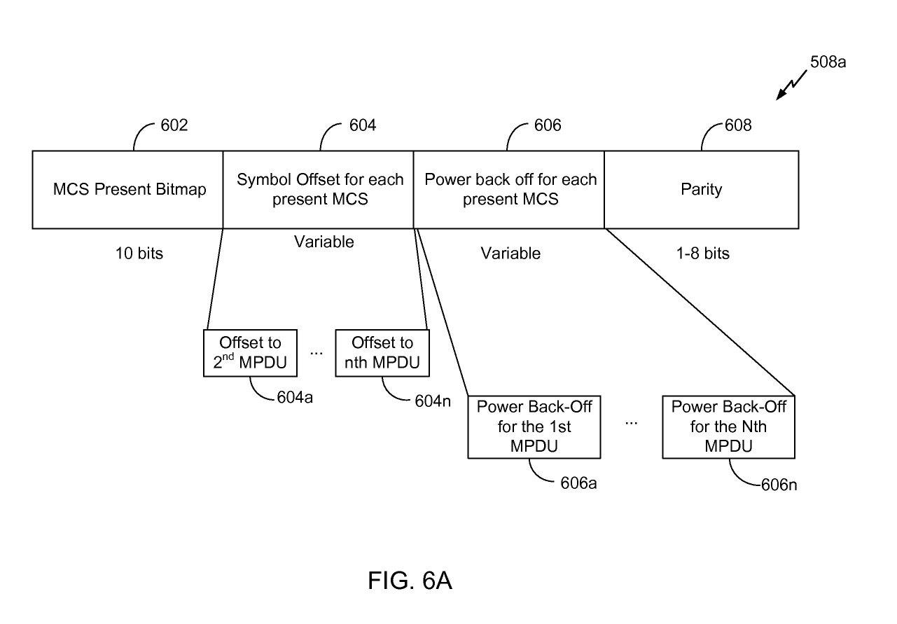

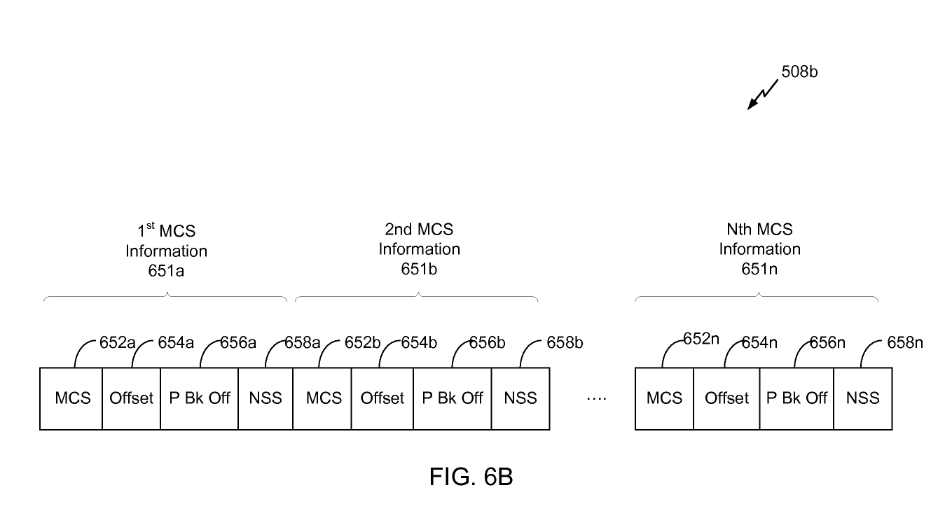

Variations on the format of SMSF 508 are shown below with respect to FIGS. 6A-B. The A-MPDU frame 500 also includes a plurality of media access control protocol data units (MPDUs). These are represented by MPDUs 510a-c. Each of the MPDUs 510a-c may be transmitted to different devices. For example, as shown in FIG. 5, MPDU 510a may be transmitted to device “destination 1” while MPDU 510b may be transmitted to a device “destination 2.” In some aspects, each of these unique destination devices may support different types of modulation and coding schemes, resulting in a different maximum throughput for transmissions from a transmitter of the frame 500 and each of the devices.

In some aspects, one or more of the MPDUs 510a-n may be transmitted to multiple devices. For example, if a plurality of devices supports a common MCS, one or more MPDUs in the A-MPDU frame 500 may be transmitted to the plurality of devices. In some aspects, the plurality of devices may be identified via a group identifier in the MPDU.

In some aspects, two or more of the MPDUs 510a-n may be transmitted using a different modulation and coding scheme. The modulation and coding scheme used to transmit each of the MPDUs 510a-n may be indicated in the SMSF field 508. Because the multiple MPDUs 510a-n are aggregated within a single A-MPDU, overhead associated with header information, such as channel training field, legacy signal fields 504, channel training fields 506, may be amortized over the multiple MPDUs. However, because two or more of the MPDUs 510a-n may be transmitted using a different MCS, a transmitting device of the A-MPDU frame 500 is not limited to using an MCS that is supported by all devices receiving any of the MPDUs 510a-n. Instead, each MPDU 510a-n may be individually tailored to its particular target device, since each MPDU can be transmitted at a different MCS if need be.

In some aspects, at least two of the MPDUs 510a-n may be separated by one or more symbols 512a-b. For example, MPDUs transmitted using different MCSs may be separated by one or more symbols 512a-b. In some aspects, the one or more symbols 512a-b may include one or more long and/or short training fields. In some aspects, the one or more symbols 512a-b may include a delimiter. The delimiter may be a predetermined series of bits that indicate the separation between two MPDUs to a device receiving the A-MPDU. For example, a delimiter within symbol(s) 512a may indicate the end of a transmission of MPDU 510a and the beginning of a transmission of MPDU 510b. In some aspects, multiple contiguous MPDUs within the A-MPDU frame 500 may be transmitted at a single MCS. In these aspects, there may not be delimiters and/or training fields between MPDUs transmitted using the same MCS.

FIG. 6A illustrates one implementation of the SMSF field 508 of FIG. 5. The SMSF field 508a may include a MCS present bitmap field 602, a symbol offset for each MCS field 604, a power back off for each MCS field 606 and a parity field 608.

In some aspects, the symbol offset for each MCS field 604 may be organized as a series of concatenated offsets, with each offset identifying a starting location of a corresponding MPDU in the A-MPDU frame 500. As shown in FIG. 6A, the symbol offset for each MCS field 604 may include an offset to each MPDU in the A-MPDU frame 500 of FIG. 5, except the first MPDU in the frame 500, since the first MPDU may be identified based on the structure of the A-MPDU frame itself. In other words, the offset to the first MPDU in the A-MPDU frame 500 may be considered to be a zero value in some aspects. As shown, the symbol offset for each MCS field 604 includes at least an offset field 604a to a second MPDU in the frame 500, and an offset field 604n for up to the nth MPDU in the frame 500.

The power back off for each MCS field 606 may have a structure similar to the symbol offset for each MCS field 604. For example, a separate power back off value may be included in the power back off for each MCS field 606 for every MPDU in the A-MPDU frame 500 of FIG. 5. As shown in the example of FIG. 6A, the power back off for each MCS field 606 includes a power back-off field 606a for the 1st MPDU in the frame 500 of FIG. 5 and a power back off field 606n for the nth MPDU in the frame 600. Thus, in some aspects, there may be N offsets included in the symbol offset for each MCS field 604 and N+1 power back off values included in the power back off for each MCS field 606.

FIG. 6B illustrates another implementation of the SMSF field 508 of FIG. 5. The SMSF field 508b. The SMSF field 508b may include MCS information 651a-n regarding use of a first MCS, a second MCS, and up to an Nth MCS during transmission of the A-MPDU frame 500. Note that while FIG. 6B shows SMSF field 508b including at least three groups of MCS information pertaining to at least three separate MPDUs (651a, 651b, and 651n), some aspects of SMSF field 508b may include information relating to only use of one MCS. In some aspects, the 1st MCS information 651a shown in FIG. 6B may relate to the MPDU 510a shown in FIG. 5. Similarly, the 2nd MCS information 651b may relate to the MPDU 510b shown in FIG. 5. In other words, the order of the MCS information 651a-n included in the SMSF field 508b may correspond to the order of the MPDUs 510a-n in A-MPDU frame 500, or the order of MPDUs 510a-n that are transmitted at different MCSs. For example, in some aspects, a first, second, and third MPDU may be transmitted at a first MCS, with a first SMSF field 508a corresponding to these first three MPDUs. A fourth and fifth MPDU may be transmitted at a second MCS, with a second SMSF field 508b corresponding to these two additional MPDUs, etc.

Each group of MCS information 651a-n shown in FIG. 6B includes up to four fields, an MCS field 652a-n, an offset field 654a-n, a power back-off field 656a-n, and a number of spatial streams (NSS) field 658a-n. The MCS field 652a-n includes a modulation and coding scheme at which a corresponding MPDU in the A-MPDU frame 500 is transmitted. For example, a corresponding MPDU for particular MPDU information in the SMSF field 508b may be the MPDU at the same ordinal position with respect to other MPDUs in the A-MPDU frame 500 as the particular MPDU information is to other MPDU information in the SMSF field 508b.

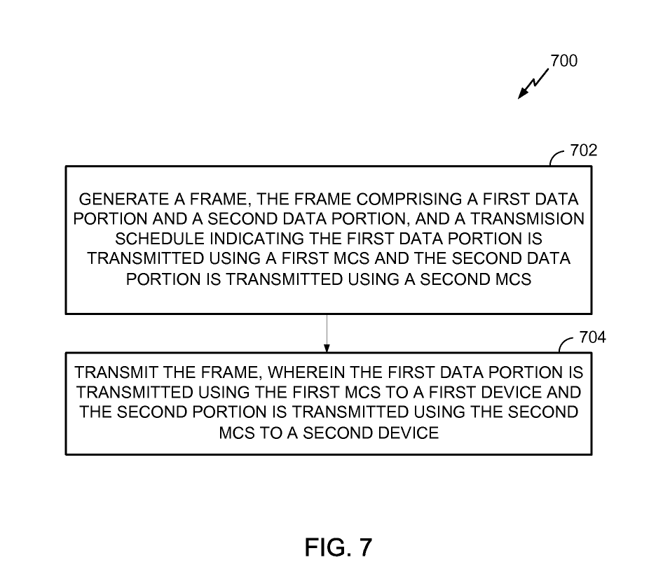

FIG. 7 illustrates a method of transmitting a wireless frame on a wireless network. The process 700 may be performed, in some aspects, by the wireless device 402 shown in FIG. 4. For example, in some aspects, the memory 406 may store instructions that configure the processor 402 to perform one or more of the functions of process 700, discussed below. In some aspects, the processor 404 may work in conjunction with the HEW Component 424 to generate and transmit the frame discussed below.

In some aspects, the process 700 is performed by an access point. The access point may utilize the frame generated and transmitted as part of process 700 to communicate with multiple wireless devices that support different modulation and coding schemes. By utilizing a single A-MPDU to communicate with these multiple devices, overhead associated with transmission of a frame, such as network bandwidth consumed by a physical protocol header, may be amortized over multiple MPDUs transmitted not only to multiple devices, but also to multiple devices supporting different modulation and coding schemes. Thus, use of process 700 presents an increased opportunity to utilize an A-MPDU to reduce network overhead when compared to previous methods.

In block 702, a frame is generated. The frame may be a physical protocol data unit. In some aspects, the frame generated in block 702 may be similar to frame 500, discussed above with respect to FIG. 5. The frame is generated to include first and second data portions, and a transmission schedule indicating that the first data portion is transmitted using a first modulation and coding scheme (MCS) and the second data portion is transmitted using a second modulation and coding scheme (MCS) that is different from the first modulation and coding scheme. In some aspects, the first and second data portions may correspond to separate MPDUs. For example, as shown in FIG. 5, the MPDUs 510a and 510b may be first and second data portions in some aspects.

In some aspects, a media access control header may be generated within each of the first data portion and second data portion. In some of these aspects, a receiver address and/or destination address field within the media access control header of the first data portion may be generated with a value that identifies a first device (such as a MAC address of the first device). In some aspects, a receiver address and/or destination address field within a media access control header of the second data portion may be generated with a value that identifies a second device (such as a MAC address of the second device).

In some aspects of block 702, the transmission schedule is generated to indicate a position of a first or starting symbol of the second data portion. For example, as described above with respect to offset fields 604a-n shown in FIG. 6A and/or offset fields 654a-n shown in FIG. 6B, the frame generated in block 702 may indicate an offset from a known position within the frame to a starting or first symbol of the second data portion. In some aspects, the frame may not include an indication of a starting symbol or first symbol of the first data portion, since the first data portion may begin at a fixed or known position within the frame. Since a length of the first data portion may be variable in nature, the starting portion of the second data portion may vary within the frame based on the length of the first portion. Thus, there may be a need to indicate the starting position for the second data portion, as well as starting portions for any third data portions, fourth data portions, nth data portion, etc included in the frame.

In some aspects, the transmission schedule is generated to further indicate a first power level used for transmission of the first portion and a second power level used for transmission of the second portion. In some aspects, the first and second power levels may be indicated by generating the transmission schedule to include a power back-off indication used to transmit each of the first and second data portions. For example, as shown with respect to fields 606a-606n of FIG. 6A and fields 656a-n of FIG. 6B, the frame may be generated to include a transmission schedule that specifies an amount of power back-off used when transmitting each of the first and second data portions. Based on the power back-off indications from the frame, a receiver may be able to determine the power used to transmit one or more of the first and/or second data portions. The power back-off and or power used to transmit the symbols within the first and/or second data portions may be used by a device receiving the first and/or second data portions to perform correct decoding of the symbols within each of the first and/or second portions.

In some aspects, the transmission schedule is generated to further indicate a first number of spatial streams used to transmit the first data portion and a second number of spatial streams used to transmit the second data portion. For example, as shown in the example transmission schedule of FIG. 6B, the MCS Information 651a-n may include, in some aspects, the number of spatial streams (NSS) field 658a-n.

In some aspects of block 702, the frame is generated to include one or more training fields between the first data portion and the second data portion. For example, one or more short and/or one or more long training fields may be included between the first data portion and the second data portion.

In some aspects of block 702, the frame is generated to include a delimiter between the first data portion and the second data portion. The delimiter may be a series of predetermined bit values that indicate to a receiving device an end of transmission of the first data portion or a boundary between a first data portion and the second data portion.

In some aspects, block 702 generates the transmission schedule to include a bitmap indicating which modulation and coding schemes are used during transmission of the frame. In some aspects, each bit of the bitmap indicates whether a particular modulation and coding scheme is used during transmission of the frame. In these aspects, the device generating the frame may determine which modulation and coding schemes are supported by devices that are addressed by MPDUs included in the A-MPDU. The device generating the frame may then determine which MCS will be used to transmit each of the data portions included in the frame based on the MCSs supported by the destination device(s). Bits in the bitmap may then be set appropriately based on the MCSs used. In some aspects, if a particular bit is not set in the bitmap, it indicates a MCS corresponding to that bit is not used during transmission of the frame. An example of an implementation using a bitmap as described above is shown in FIG. 6A. The MCS present bitmap field 602 may include a bit for each MCS that can be utilized in transmission of an A-MPDU. In a particular A-MPDU, only bits in the MCS Present Bitmap 602 corresponding to MCSs actually used in the transmission (of the frame 500 of FIG. 5 for example), will be set. One of ordinary skill in the art would understand that in some other implementations, clear bits could indicate that a particular MCS is used in the transmission (as opposed to set bits as described above).

In some aspects of block 702, the frame is generated so as to order the transmission of the first data portion and the second data portion within the frame based on the first modulation and coding scheme (MCS) and the second modulation and coding scheme. For example, some aspects, may order data portions from lower to higher MCS. This may ensure that devices supporting lower MCS's can identify starting positions of data portions addressed to them, without having to decode data transmissions transmitted at higher MCSs which they do not support.

In some aspects, one or more of the functions discussed above with respect to block 702 may be performed by the multiple MCS frame encoder/decoder 428 and/or the processor 404. In some other aspects, one or more of these functions may be performed by the DSP 420, and/or the signal detector 418. In some aspects, generating the frame may include determining a portion of memory 406 that is unused and large enough to store the generated frame. A starting position of the portion of memory 406 for the frame may also be determined. Values of the portion of memory 406 may then be set by the processor 404 to indicate the frame characteristics as described above. For example, bit values of the portion of memory may be set to represent the first data portion and second data portion, and the transmission schedule as described above.

In block 704, the frame generated in block 702 is transmitted. The first data portion of the frame is transmitted using the first MCS to a first device. For example, as described above, a media access control header included in the first data portion may have a receiver and/or destination address generated to be a value that identifies the first device (for example, one or both of these address fields may be set to a MAC address of the first device). In some aspects, the first data portion of the frame may be transmitted or addressed to a plurality of devices. For example, in some aspects, the first portion may include a group identifier for the plurality of devices. The second data portion may be generated as described above such that a receiver address and/or destination address within a media access control header of the second data portion may identify the second device (for example, by the MAC address of the second device). In some aspects, the second data portion of the frame is transmitted or addressed to a plurality of devices.

In some aspects, block 704 may include transmission of a guard interval between transmission of the first data portion and transmission of the second data portion of the frame. In some aspects, a transition from transmission at the first MCS to the second MCS may occur during the transmission of the guard interval.

In some aspects, one or more of the functions discussed above with respect to block 704 may be performed by the transmitter 410. In some other aspects, one or more of these functions may be performed by the transceiver 414, DSP 420, and/or the signal detector 418, and/or the processor 404. In some aspects, transmitting the frame may include indicating to the transmitter 410 the location of the portion of memory 406 discussed above. For example, one or more registers of the transmitter 410 may be written by the processor 404 to indicate a starting position of the frame. Transmitting the frame may also include signaling the transmitter 410 that the transmission should be initiated. For example, other register(s) of the transmitter 410 may be written to initiate the transmission. Alternatively, an interrupt signal may be generated, directly or indirectly, by the processor 404 and provided to the transmitter 410 to initiate transmission.

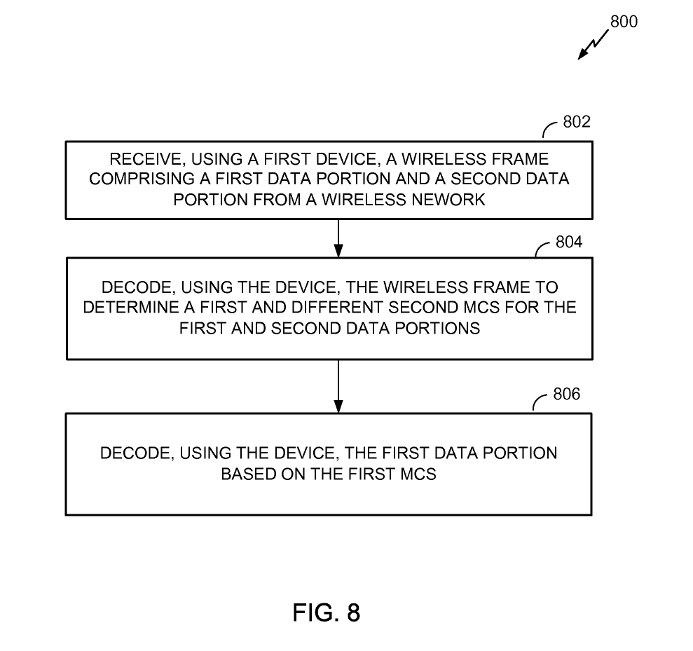

FIG. 8 illustrates a method of receiving a wireless frame from a wireless network. In some aspects, the wireless frame is an aggregated media access control protocol data unit (A-MPDU). The wireless frame received by process 800 may include data transmitted using multiple modulation and coding schemes. The process 800 may be performed, in some aspects, by the wireless device 402 shown in FIG. 4. For example, in some aspects, the memory 406 may store instructions that configure the processor 404 to perform one or more of the functions discussed below with respect to process 800.

In some aspects, the process 800 is performed by a station in communication with an access point. By receiving and decoding a single wireless frame that includes multiple data portions transmitted using multiple modulation and coding schemes, devices performing process 800 facilitate increased opportunities for the use a wireless frame including data portions addressed to different devices that support different modulation and coding schemes. This may result in reduced network overhead compared to known methods.

In block 802, a wireless frame is received from the wireless network. The wireless frame includes a plurality of data portions, including at least a first and second data portion. In some aspects, the wireless frame received in block 802 is an aggregated media access control protocol data unit (A-MPDU), and each of the data portions are MPDUs. For example, in some aspects, the frame received in block 802 may substantially conform with the frame 500 discussed above with respect to FIG. 5. In some aspects, one or more functions discussed above with respect to block 802 may be performed by the receiver 412 and/or the processor 404. In some aspects, receiving the frame may include the receiver 412 decoding signals received over the antenna 416 to determine bit values of the received frame. The bit values determined by the receiver 412 may then be copied from the receiver 412 to the memory 406. In some aspects, the receiver 412 may perform the copy operation. In other aspects, the processor 404 may perform the copy operation. In some other aspects, a DMA (direct memory access) operation may facilitate copy of data frame values from the receiver 412 to the memory 406.

In block 804, the wireless frame is decoded to determine a first and second modulation and coding scheme (MCS) for a first and second data portion in the plurality of data portions included in the wireless frame. In some aspects, a transmission schedule is included in the wireless frame and is decoded to determine the first and second MCSs. For example, as shown in FIG. 6A, in some aspects an MCS present bitmap 602 may be included in the wireless frame received in block 802. In these aspects, the MCS present bitmap 602 may be decoded to determine which MCSs are used to transmit data portions within the wireless frame. In some aspects, one or more data portions may be transmitted at the first MCS and one or more data portions may be transmitted at the second MCS. For example, multiple MPDUs may be received at the first MCS and/or multiple MPDUs may be received at the second MCS.

As another example, in some aspects, a transmission schedule such as that shown in FIG. 6B may be included in the wireless frame received in block 802. In these aspects, the first, second, and/or nth MCS information 651a-n may be decoded from the wireless frame by the first device. For example, one or more of the MCS fields 652a-n may be decoded to determine an MCS used for each data portion included in the wireless frame received in block 802. In some aspects, one or more functions discussed above with respect to block 804 may be performed by the multiple MCS frame encoder/decoder 428, and/or the processor 404 and/or the DSP 420 and/or the signal detector 418. For example, decoding the wireless frame may include extracting bit values from two portions of the received frame, the two portions offset from the beginning of the wireless frame based on the frame format, such as that disclosed above in FIGS. 5, 6A, and 6B. The extracted bit values may then be interpreted as MCS values, as described above for example with respect to fields 652a and 652b.

In block 806, the first data portion is decoded from the wireless frame based on the first modulation and coding scheme. In some aspects, the decoding of the first data portion is in response to a determination that the first data portion can be decoded by the first device based on the first MCS. For example, the first MCS may be supported by the first device, and thus, the first device may be able to decode the first data portion from the wireless frame received in block 802. In some aspects, the decoding determines a destination address of the first data portion. In some aspects, the first device may determine whether the first data portion is addressed to the first device by comparing the destination and/or receiver address fields of the first data portion to a MAC address of the first device. If the destination and/or receiver address fields of the first data portion are equivalent to the MAC address of the first device, the first device may determine the first data portion is addressed to the first device, and the first device may further process the first data portion based on such a determination. For example the first data portion may be passed to higher layer protocol processing methods and/or application programs within the first device. Alternatively, if the first device determines the first data portion is not addressed to the first device, no further processing may be performed on the first data portion. In some aspects, additional data portions, such as MPDUs may be decoded from the wireless frame using the first MCS.

In some aspects of block 806, the first data portion is decoded from the wireless frame based on an offset value included in the wireless frame. For example, as shown in FIG. 6A, in some aspects, an offset value included in any one of the offset fields 604a-n may indicate a starting or first symbol of a data portion. In some aspects, the data portion may be the first data portion. Similarly, in aspects implementing the transmission schedule shown in FIG. 6B, the offset value may be decoded from any one of the offset fields 654a-n. The offset value may be used by the first device to identify a starting or first symbol of the first data portion in some aspects.

In some aspects of block 806, the transmission schedule included in the received wireless frame may be decoded to determine a transmission power or a transmission power back-off used to transmit the first data portion. For example, as shown in FIG. 6A, a transmission schedule may include the power back-off field 606a-n. In these aspects, the first device may decode the received wireless frame to determine the power back off used to transmit the first data portion. Decoding of the first data portion may then be based on the power back off information included in the field 606a.

In some aspects of block 806, the second data portion is decoded based on the second modulation and coding scheme. In some aspects, the second data portion is decoded from the wireless frame to determine a destination address of the second data portion. In some aspects, the second data portion is decoded in response to a determination that the first device supports the second modulation and coding scheme and can thus properly decode the second data portion. In some aspects, the first device may determine whether the second data portion is addressed to the first device by comparing the destination and/or receiver address fields of the second data portion to a MAC address of the first device. If the destination and/or receiver address fields of the second data portion are equivalent to the MAC address of the first device, the first device may determine the second data portion is addressed to the first device, and the first device may further process the second data portion based on such a determination. For example the second data portion may be passed to higher layer protocol processing methods and/or application programs within the first device. Alternatively, if the first device determines the second data portion is not addressed to the first device, no further processing may be performed on the second data portion.

In some aspects of block 806, the second data portion is decoded from the wireless frame in block 808 based on an offset value included in the wireless frame. For example, as shown in FIG. 6A, in some aspects, an offset value included in any one of the fields 508a-n may indicate a starting or first symbol of a data portion. In some aspects, the data portion may be a second data portion. Similarly, in aspects implementing the transmission schedule shown in FIG. 6B, the offset value may be decoded from any one of the offset fields 654a-n. The offset value may be used by the first device to identify a starting or first symbol of the second data portion in some aspects.

In some aspects of block 806, the transmission schedule included in the received wireless frame may be decoded to determine a transmission power or a transmission power back-off used to transmit the second data portion. For example, as shown in FIG. 6A, a transmission schedule may include the power back-off field 606a-n. In these aspects, the first device may decode the received wireless frame to determine the power back off used to transmit the second data portion. Decoding of the second MPDU may then be based on the power back off information included in the field 606n. Similarly, in aspects implementing the transmission schedule shown in FIG. 6B, a power back off field such as any of 656a-n may be decoded to determine a power at which the second data portion is transmitted. Decoding of the second data portion may then be based on the power back off information included in the field 656a-n.

In some aspects of block 806, the transmission schedule included in the received wireless frame may be decoded to determine a first number of spatial streams encoding the first data portion and/or a second number of spatial streams encoding the second data portion. For example, as shown in FIG. 6B, in some aspects, the wireless frame received in block 802 may include fields 658a-n or their equivalent. In these aspects, the first device may be configured to decode one of the fields 658a-n to determine the number of spatial streams encoding a particular data portion, and decode the particular data portion based on the determined number of spatial streams.

In some aspects, one or more functions discussed above with respect to block 806 may be performed by the multiple MCS frame decoder 428, and/or the processor 404 and/or the DSP 420 and/or the signal detector 418. In some aspects, decoding the first data portion based on the first MCS may include determining a number of amplitudes and/or number of phase shifts utilized to encode one or more symbols of a received signal based on the first MCS, determining which of the determined amplitudes and phase shifts are present in a received signal, and identifying one or more symbols encoded by the received signal based on the present amplitudes, and phase shifts.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of communicating on a wireless network, comprising:
generating a physical protocol data unit, the physical protocol data unit including:
a first data portion and a second data portion, and
a transmission schedule indicating the first data portion is transmitted using a first modulation and coding scheme and the second data portion is transmitted using a second modulation and coding scheme; and
transmitting the physical protocol data unit, wherein the first data portion is transmitted using the first modulation and coding scheme to a first device and the second data portion is transmitted using the second modulation and coding scheme to a second device.

2. The method of claim 1, further comprising generating the transmission schedule to further indicate a first power level used for transmission of the first data portion and a second power level used for transmission of the second data portion.

3. The method of claim 1, further comprising transmitting a guard interval between transmission of the first data portion and the second data portion, wherein the transmission of the guard interval comprises transitioning from transmitting at the first modulation and coding scheme to transmitting at the second modulation and coding scheme.

4. The method of claim 1, further comprising generating the physical protocol data unit to further comprise one or more training fields between the first data portion and the second data portion.

5. The method of claim 1, further comprising generating the transmission schedule to indicate a first number of spatial streams used to transmit the first data portion and a second number of spatial streams used to transmit the second data portion.

6. The method of claim 1, further comprising:
generating the transmission schedule to include a bitmap indicating modulation and coding schemes used during transmission of the physical protocol data unit;
first determining the first device may receive data using the first modulation and coding scheme;
setting a first bit in the bitmap corresponding to the first modulation and coding scheme based on the first determining;
second determining the second device may receive data using the second modulation and coding scheme; and
setting a second bit in the bitmap corresponding to the second modulation and coding scheme based on the second determining.

7. The method of claim 1, further comprising ordering the first data portion and the second data portion in the physical protocol data unit based on the first modulation and coding scheme and the second modulation and coding scheme.

8. An apparatus for communicating on a wireless network, comprising:
a processor configured to generate a physical protocol data unit, the physical protocol data unit including:
a first data portion and a second data portion, and
a transmission schedule indicating the first data portion is transmitted using a first modulation and coding scheme (MCS) and the second data portion is transmitted using a second modulation and coding (MCS) scheme; and
a transmitter configured to transmit the physical protocol data unit, wherein the transmitter is configured to transmit the first data portion using the first modulation and coding scheme to a first device and the transmitter is configured to transmit the second data portion using the second modulation and coding scheme to a second device.

9. The apparatus of claim 8, wherein the transmitter is further configured to transmit the first data portion of the physical protocol data unit to a third device.

10. The apparatus of claim 9, wherein the transmitter is further configured to transmit the second data portion of the physical protocol data unit to a fourth device.

11. The apparatus of claim 8, wherein the processor is further configured to generate the transmission schedule to further indicate a starting symbol of the second data portion.

12. The apparatus of claim 8, wherein the processor is further configured to generate the transmission schedule to further indicate a first power level used for transmission of the first data portion and a second power level used for transmission of the second data portion.

13. The apparatus of claim 8, wherein the processor is further configured to transmit a guard interval between transmission of the first data portion and the second data portion, wherein the transmission of the guard interval comprises transitioning from transmitting at the first modulation and coding scheme to the second modulation and coding scheme.

14. The apparatus of claim 8, wherein the processor is further configured to generate the physical protocol data unit to further comprise one or more training fields between the first data portion and the second data portion.

15. The apparatus of claim 8, wherein the processor is further configured to:
generate the transmission schedule to include a bitmap indicating modulation and coding schemes used during transmission of the physical protocol data unit,
determine whether the first device may use the first modulation and coding scheme,
set a first bit in the bitmap corresponding to the first modulation and coding scheme in response to determining that the first device may use the first modulation and coding scheme,
determine whether the second device may use the second modulation and coding scheme, and
set a second bit in the bitmap corresponding to the second modulation and coding scheme in response to determining that the second device may use the second modulation and coding scheme.

16. The apparatus of claim 8, wherein the processor is further configured to order the first data portion and the second data portion in the physical protocol data unit based on the first modulation and coding scheme and the second modulation and coding scheme.

17. An apparatus for communicating on a wireless network, comprising:
a receiver configured to receive a physical protocol data unit from the wireless network, the physical protocol data unit including a first data portion and a second data portion;
a processor configured to:
decode the physical protocol data unit to determine a first modulation and coding scheme of the first data portion and a second different modulation and coding scheme of the second data portion, and
decode the first data portion based on the first modulation and coding scheme.

18. The apparatus of claim 17, wherein the processor is further configured to:
determine whether the first modulation and coding scheme is supported by the apparatus,
decode the first data portion to determine a destination address of the first data portion and determine if the destination address of the first data portion identifies the apparatus in response to the determining that the first modulation and coding scheme is supported by the apparatus, and
further decode the first data portion in response to the destination address identifies the apparatus.

19. The apparatus of claim 17, wherein the processor is further configured to:
decode the physical protocol data unit to determine an offset to a starting symbol of the first data portion, and
decode the first data portion based on the offset.

20. The apparatus of claim 17, wherein the processor is further configured to:
decode the physical protocol data unit to determine a transmission power back-off of the first data portion, and
decode the first data portion based on the transmission power back-off.
